(19) United States
(12) Patent Application Publication
(10) Pub. No.: US 2016/0164962 A1
(43) Pub. Date: Jun. 9, 2016

(54) Reducing the Impact of Noisy Neighbors via Pro-Active Log Offloading in Shared Storage Environment

(71) Applicant: International Business Machines Corporation, Armonk, NY (US)

(72) Inventors: Rahul Ghosh, Morrisville, NC (US); Aaron J. Quirk, Cary, NC (US)

(21) Appl. No.: 14/562,457

(22) Filed: Dec. 5, 2014

(51) Int. Cl. H04L 29/08; H04L 12/26

(52) U.S. Cl. CPC H04L 67/1008; H04L 67/1097; H04L 43/04

(57) ABSTRACT

Methods and systems may provide for reducing workloads of neighboring virtual machine tenants in a cloud environment with shared storage using pro-active log offloading. Additionally, logging activity may be redirected to reduce input/output resource consumption. Trends in future input/output activities may be determined and preemptive action may be implemented to reduce performance impact of the neighboring tenants.

### BACKGROUND

Embodiments of the present invention generally relate to a cloud workload lowering its input/output requirements to reduce the impact of a “noisy” workload peer sharing the same disks. More particularly, embodiments relate to the redirecting and offloading of excessive logging that may be aggravating the input/output resource consumption in a shared storage environment.

Sustained high input/output (I/O) generated by running processes may trigger many unwanted events such as starvation of other processes, high response time, file system corruption, etc. The unwanted events may be common in large data environments where workloads may be data intensive and may require frequent writes to large databases. Built-in logging mechanisms may add to the overall I/O of a system. While logs may be useful for system diagnostics, huge volumes of logging activity may be undesirable to system mechanics. Shared storage may be a key component of cloud computing environments because it may enable economies of scale, more drives in a given array and may facilitate live migration of virtual machines (VMs) from one compute resource to another. I/O spikes, however, from one tenant/peer bleeding into the usage of another tenant may adversely affect the performance of the second tenant. The second tenant's performance may be degraded when impacted by an unrelated workload that shares the same set of disks in an array. Such performance impact by a co-located tenant may be designated as “noisy tenant”. Methods may exist that establish boundaries around storage volumes assigned to a particular system to limit input/output operations per second (IOPs) to minimum and maximum values but the boundaries may not be available to cloud shared-storage infrastructures.

### BRIEF SUMMARY

Embodiments may also include a method to enhance tenant performance in a cloud shared-storage environment, comprising determining current input/output characteristics of an application enabled on a virtual machine, selecting and offloading logs based on trends found in the input/output characteristics, and aggregating portions of the logs that have been directed to separate file locations.

Embodiments may also include a computer program product comprising a cloud shared-storage medium and computer usable code stored on the cloud shared-storage medium, where if executed by a processor, the computer usable code causes a computer to determine current input/output characteristics of an application enabled on a virtual machine, select and offload logs based on trends found in the input/output characteristics, and aggregate portions of the logs that have been directed to separate file locations.

Embodiments may include a VM product comprising a cloud shared-storage medium, a cloud management infrastructure and computer usable code stored on the shared-storage medium, where if executed by a processor, the computer usable code may cause a computer to determine current input/output characteristics of an application enabled on a virtual machine, predict a future workload on a disk system using the input/output characteristics, rank prior log-offloading activity on the disk system using the current input/output characteristics, select and offload logs based on trends found in the input/output characteristics, monitor the select and offload activity of the logs to control a configuration of the disk system, aggregate portions of the logs that have been directed to separate file locations, and pull the portions of the logs from remote locations and relocate the portions back into original positions in the virtual machine.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a flowchart of an example of a computer implemented method to enhance tenant performance in a cloud shared-storage environment according to an embodiment;

FIG. 2 is a block diagram of an example of computer program product according to an embodiment; and

FIG. 3 is a block diagram of an example of a virtual machine product according to an embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

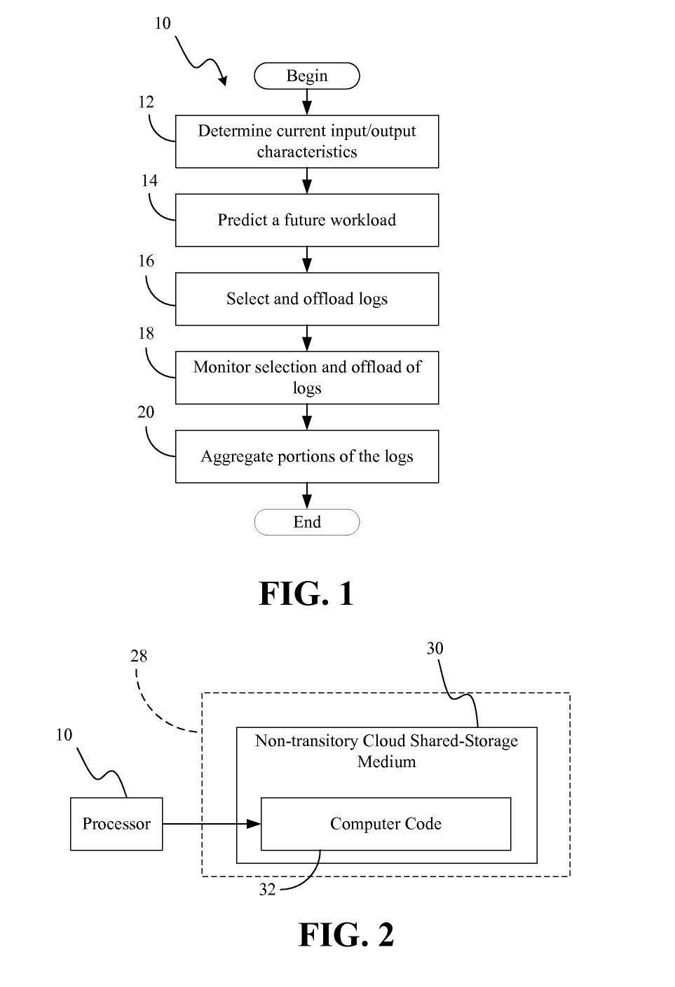

FIG. 1 shows a computer implemented method 10 to enhance tenant performance in a cloud shared-storage environment. A designated VM connected to a shared-storage medium (see FIG. 2) may be deployed to enable an application. Current I/O characteristics of the application may be determined at block 12. For example, an application that enables verbose tracing may fill many gigabytes of disk space when under heavy load. Also, there may be a priority of one tenant versus another tenant based on an I/O workload. A future I/O workload on the VM may be predicted at block 14. Trends in the I/O characteristics of the application may be determined to aid in determining the future workload.

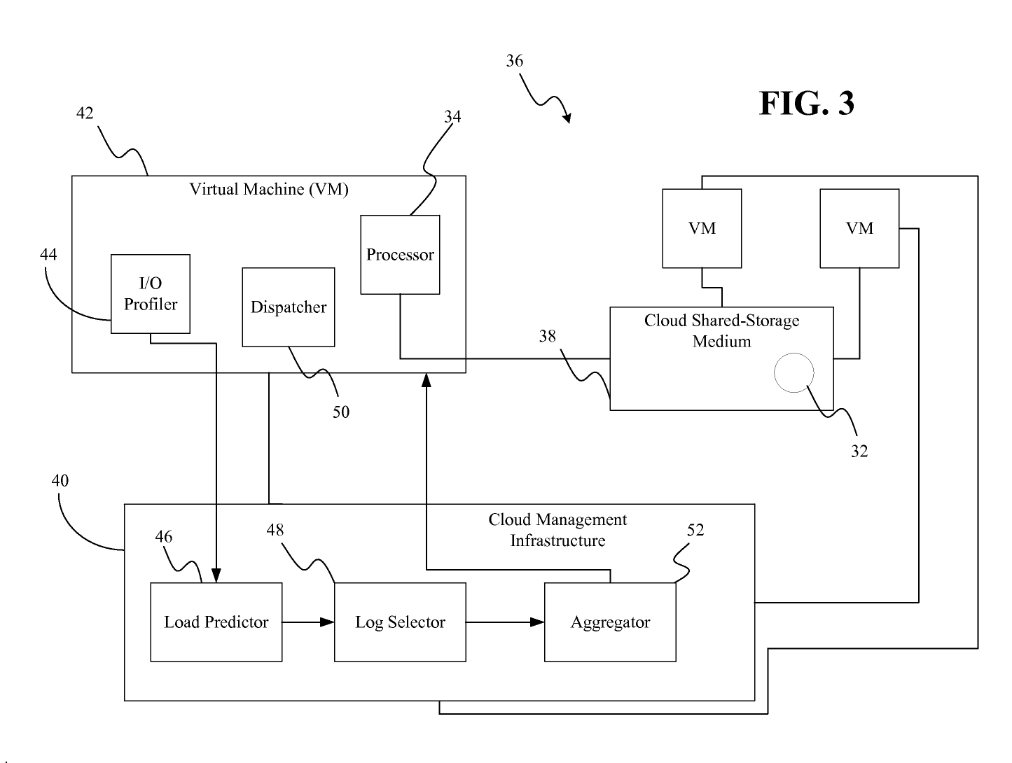

Several VMs may be located on the cloud-shared storage environment (see FIG. 3) and may be ranked based on their I/O activity. Ranking may take into account prior log-offloading activity by the designated VM. For example, if two VMs are predicted to have I/O but only one of them conducted log offloading in the past, the other VM may be chosen for the next turn. Periodically data may be sent back to the VM as a feedback loop. Once the VMs are identified and ranked to predict future workload activity, logs may be selected for offloading and relocating at block 16 to selected locations in the cloud shared environment. Examples of logging that may be offloaded may include same types of information that may be used and stored across multiple log file (for example each log-file containing details about product version, trace setting etc.), logs that may be collected only for reports generating purposes but not for immediate consumption and action by other system components, and system dumps in case of a failure etc.

After offloading of the selected logs has occurred, usage of the VM may be monitored at block 18 to ascertain whether the VM activity has returned to its original values. For example, criteria may be considered after a prescribed time has elapsed and/or whether I/O conditions of the VM meet acceptable load levels. Due to the offloading and relocating activities, logs may be fragmented across one or more VM systems of control. Portions of the fragmented logs may be aggregated at block 20 to reconcile any/all log portions that may have been separated. Aggregation may be performed by a background reconciliation approach automatically where log content from a remote location may be pulled back onto the original source VM, or using a dynamic reconciliation approach where a user may manually enable remote sources to build a dynamic representation of a single log file.

Turning now to FIG. 2, a computer program product 28 may be used to reduce the impact of “noisy” neighbors as an example of an embodiment, is shown. A non-transitory cloud shared-storage medium 30 within the computer program product 28 may be available to numerous VMs with different tenant workload requirements (see FIG. 3). Computer usable code 32 stored in the non-transitory cloud shared-storage medium 30 may be enabled by a processor 34 to execute the method 10 shown in FIG. 1.

FIG. 3 shows a virtual machine product 36 that may be used to reduce the impact of “noisy” neighbors as an example of an embodiment. In FIG. 3 numerous VMs 42 may be deployed in a cloud environment to execute designated applications using, for example a processor 34. The VMs 42 may share a cloud shared-storage medium 38 and a cloud management infrastructure 40. In the virtual machine product 36, the VM 42 may include an I/O profiler 44. The I/O profiler 44 may monitor the performance of a disk subsystem and periodically provide feedback to the VM 42 regarding VM workload activities. The I/O profiler 44 may determine current I/O characteristics of the designated application. The I/O profiler 44 may use current techniques such as putting boundaries around storage volumes assigned to a VM 42 to limit I/O operations to maximum/minimum values to assist with its prediction of future workload requirements for a particular VM 42.

The cloud management infrastructure 40 may include a load predictor 46 to determine trends in patterns of the I/O characteristics. Communications between the I/O profiler 44 and the load predictor 46 may enable the virtual machine product 36 to implement preemptive action to pro-actively offload logging activities. The load predictor 46 may rank the VMs 42 based on their workload activities. In ranking, the load predictor 46 may take into account prior log-offloading activity by the VM 42. A log selector 48 may be located in the cloud management infrastructure 40 to determine what logs to offload and what logs to keep as determined by the trends in the patterns of the I/O characteristics identified by the load predictor 46. The log selector 48 may also designate the location to offload a particular log. Logging activities may include same types of information that may be used to store across multiple files, logs that may be collected only for reports of low priority and system dumps.

A dispatcher 50 may be located in the VM 42 to make changes to logging activities when requested. The dispatcher 50 may be in communication with the cloud management infrastructure 40 to maintain control of the logging activities. After offloading, the I/O profiler 44 may monitor usage of a target VM 42. The I/O profiler 44 may ascertain whether a workload activity of the particular VM 42 has returned to original values after one or more criteria have been resolved. Prescribed time and I/O conditions meeting acceptable load levels may be factors used by the I/O profiler 44 during its monitoring. After offloading, the logs may be fragmented across one or more VMs 42. The cloud management infrastructure 40 may include an aggregator 52 to reconcile log portions that may have been separated. The aggregator 52 may automatically recombine the log portions in a background reconciliation process or, when requested by a user, implement a manual dynamic re-composition.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A computer program product comprising a cloud shared-storage medium and a computer usable code stored on the cloud shared-storage medium, where if executed by a processor, the computer usable code causes a computer to:
determine current input/output characteristics of an application enabled on a virtual machine;
predict a future workload on a disk system using the input/output characteristics;
rank prior log-offloading activity on the disk system using the current input/output characteristics;
select and offload logs based on trends found in the input/output characteristics;
monitor the select and offload activity of the logs to control a configuration of the disk system;
aggregate portions of the logs that have been directed to separate file locations; and
pull the portions of the logs from remote locations and relocate the portions back into original positions in the virtual machine.

2. The computer program product of claim 1, wherein the computer usable code, if executed, causes the computer to aggregate portions of the logs as a dynamic re-composition when requested by a user.

3. The computer program product of claim 1, wherein the computer usable code, if executed, causes the computer to select and offload the logs with same types of information that are used in the cloud shared-storage environment across multiple logs, logs that are collected only for reports that generate purposes not for immediate consumption and action by other computer system components, and computer system dumps in case of a failure.

4. The computer program product of claim 1, wherein the computer usable code, if executed, causes the computer to use a feedback loop to determine future input/output needs and what logs to offload and relocate.

5-12. (canceled)

13. A computer program product, comprising:
a cloud shared-storage medium; and
computer usable code stored on the cloud shared-storage medium, where if executed by a processor, the computer usable code causes a computer to:
determine current input/output characteristics of an application enabled on a virtual machine;
select and offload logs based on trends found in the input/output characteristics; and
aggregate portions of the logs that have been directed to separate file locations.

14. The computer program product of claim 13, wherein the computer usable code, if executed, causes the computer to predict a future workload on a disk system.

15. The computer program product of claim 14, wherein the computer usable code, if executed, causes the computer to rank prior log-offloading activity.

16. The computer program product of claim 13, wherein the computer usable code, if executed, causes the computer to monitor the selecting and offloading of the logs to control a configuration of the disk system.

17. The computer program product of claim 13, wherein the computer usable code, if executed, causes the computer to pull the portions of the logs from remote locations and relocate the portions back into original positions in the virtual machine.

18. The computer program product of claim 13, wherein the computer usable code, if executed, causes the computer to aggregate portions of the logs as a dynamic re-composition when requested by a user.

19. The computer program product of claim 13, wherein the computer usable code, if executed, causes the computer to select and offload the logs with same types of information that are used in the cloud shared-storage environment across multiple logs, logs that are collected only for reports that generate purposes not for immediate consumption and action by other computer system components, and computer system dumps in case of a failure.

20. The computer program product of claim 13, wherein the computer usable code, if executed, causes the computer to use a feedback loop to determine future input/output needs and what logs to offload and relocate.
